(19) United States
(12) Patent Application Publication
(10) Pub. No.: US 2005/0165760 A1
(43) Pub. Date: Jul. 28, 2005

(54) Auto version managing system and method for use in software

(75) Inventor: Jung-soo Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung electronics Co., Ltd.

(21) Appl. No.: 11/039,851

(22) Filed: Jan. 24, 2005

(30) Foreign Application Priority Data
Jan. 28, 2004 (KR) 10-2004-0005288

(51) Int. Cl. G06F 7/00

(52) U.S. Cl. 707/3

(57) ABSTRACT

An auto version managing system for software including a search module for searching at least one folder and file structure in the software and for indexing the folder and file, a version managing database (DB) for storing software version information including at least one of a software version, file properties, checksum, and version history, and a checksum calculation part for calculating a checksum of the folder and the file. The system further includes a checksum comparison part for comparing the checksums of the software of an old version that are stored in the version managing DB with the checksums of an upgraded software, and then extracting one of the changed folder(s) and file(s). The system still further includes a DB generation part for storing information about the extracted folder or file in the version managing DB, such that a DB of the software version history can then be automatically generated.

### CROSS-REFERENCE TO RELATED APPLICATIONS

This application claims the benefit under 35 U.S.C. §119(a) of Korean Patent Application No. 10-2004-0005288 filed in the Korean Intellectual Property Office on Jan. 28, 2004, the entire contents of which are incorporated herein by reference.

### BACKGROUND OF THE INVENTION

1. Field of the Invention

The present invention relates to an auto version managing system and method for use in software. More specifically, the present invention relates to an auto version managing system and method featuring an effective management of version history of software provided by generating a new checksum for each folder and file in the software, comparing the new checksum with the previous checksum of each folder and file in the software of an old version to select or extract changed folders and files, and automatically storing information about the changed folders and files in a database (DB) and generating a version history.

2. Description of the Related Art

Rapid developments and advances of information technologies in recent years have brought dramatic changes in the performance of information processing devices. According to Moore's law, which states that the complexity of integrated circuits or microchips doubles every 18 months, at the current rate of technological development and advances in the computer industry, the data processing performance and memory capacity of the computer doubles every 18 months. While the performance of the computer has advanced and the components on semiconductor chips have been diversified, the cost thereof has been lowered. Therefore, users tend to continuously upgrade (or version-up) computer hardware to maintain the best and most stable performance for their computer.

The technological developments and advances are also observed in computer software. For example, a new function is added to the software, or a version upgrade is made to delete a bug that is observed in an old version. In general, the software manufacturer offers an upgraded software at a lower price. The user typically verifies that they are authorized users of an old version, or have the old software installed in their computers.

Versions are usually numbered in sequence according to a stage of the product development process of the same software, and are given to more effectively manage the software. Generally, there is an α-version and a β-version, which are pre-release versions with experimental features subject to change, and the full entitled version. A version number of the full entitled version includes two parts, that is, the primary version number in front of the decimal point, and the secondary version number after the decimal point. If functions and contents of the software have changed a great deal, the primary number of the version is changed, such as 2.0 to 3.0. If the change is minor, such as those involving debugging or troubleshooting only, the secondary number of the version is changed, such as 1.1 to 1.2. However, the version number does not have to be two digit numbers. For instance, MS-Windows used to be numbered according to the above rule system. But after MS-Windows 3.1, the year of manufacture has been used as a new product version name, that is, Windows 95, Windows 98, and Windows 2000. Later, Microsoft again changed version naming schemes to WindowME, Windows XP, and so on.

As software needs to be continuously upgraded to meet external or internal demands such as rapid advances in hardware technology and diverse requests of customers, software manufacturers have started considering methods to more systematically manage the upgraded contents and upgrade history of each software.

In the past, a software manufacturer (or programmer) personally managed the version history (that is, version changes) of a software by comparisons with an old version, and traced the changes in folders and file contents. Although there was a tool available to compare a binary file of the old version with a binary file of the later (or the latest) version and find changed files, the software manufacturer (or programmer) still had to manually gather the information about the changed files, the reasons for upgrades, which functions have been upgraded, and so on. This work was tedious and burdensome to many because the software could be tens of megabytes (MB), and up to several gigabytes (GB) in size, and typically has at least one folder with numerous subfiles or lower-level files.

FIG. 1 illustrates a partially opened folder directory in an MFP driver that supports an MFP. Referring to FIG. 1, the MFP driver includes a plurality of folders, and the Driver folder among them has lower-level folders labeled CF-555P and SF-555P. By continuously opening the folders, one realizes that the Driver folder ultimately includes 5-level subfolders. When the user clicks the lowest folder labeled Win2K for example, he or she can see dozens of files under the folder as shown on the right side of the window. That is, one single software can have tens or hundreds of multi-level subfolders and countless files under the folders.

Therefore, it takes a significant amount of time, effort and cost to manually compare such a large number of files and folders one by one for the management of version history of the upgraded software. Moreover, during the manual work, there is always the possibility for software manufacturers or programmers to make mistakes, although unintentional, and change the wrong files and/or folders. When this happens, product quality of the software becomes inevitably deteriorated.

Using a file comparison tool for comparing binary files has a benefit in that the manufacturers provide the comparison tools to address the time and effort required for tasks being performed manually. However, the tools compare every lowest-level file under each folder with the old version files in order to identify changes in the binary files. Thus, this method also takes a significant amount of time and cost to compare countless files. Another problem is that the tools compare binary files based on the limited information comprising file property, size, update date, and file version. For example, when file size and update date are the same, the tool often fails to detect changes made in the binary file despite the fact that the binary file had indeed been changed. Thus, binary file comparison based on limited information is not an effective way to manage a more accurate history of the version.

Accordingly, a need exists for an automatic version managing system and method for more conveniently managing the history of a version of a software system. In this manner, a significant amount of time, effort and cost in managing the version history of a software can be saved.

### SUMMARY OF THE INVENTION

It is, therefore, an aspect of the present invention to provide an auto version managing system and method for use in software, enabling a more effective management of the version history of the software and thereby saving a significant amount of time and cost. The system calculates the checksums of folders, subfolders, and files of the upgraded software, respectively, and compares the checksum calculations with the checksums of folders, subfolders, and files in the software of an old version in order to identify and select changed folder(s), subfolder(s), and file(s), and store information about the changed folder(s), subfolder(s), and file(s) in the version managing database (DB). The system can then generate the history of the software version.

To achieve the above aspects and advantages, an auto version managing system is provided for use in software being loaded in a terminal for managing the version history of the software. The system includes a search module for searching at least one folder and file structure in the software and indexing the folder and file, a version managing DB for storing software version information including at least one of the software version, file properties, checksum, and version history, a checksum calculation part for calculating the checksum of the folder and the file, respectively, and a checksum comparison part for comparing the checksums of the software of the old version that are stored in the version managing DB with the checksums of an upgraded software and identifying and extracting one of the changed folder(s) and file(s). The system further includes a DB generation part for storing information about the extracted folder or file, which is provided from the checksum comparison part, in the version managing DB.

Preferably, the software includes at least one of an O/S loaded in the terminal, application program, and device driver.

In the exemplary embodiment, the checksum calculation part calculates the checksums of folders, subfolders and files in the upgraded software, respectively, and the checksum comparison part sequentially compares the checksums of the folders, subfolders and files to identify and extract changed folder(s), subfolder(s) and file(s).

In the exemplary embodiment, the DB generation part classifies the information including the version history of the changed folder(s), subfolder(s) and file(s) that are extracted by the checksum comparison part in accordance with a version system of the software, and stores the information in the version managing DB.

Another aspect of the present invention provides an auto version managing method for software loaded in a terminal for an effective management of the version history of an upgraded software. The method includes the steps of searching at least one folder and file structure in the software and indexing the folder and file, calculating the checksum of each folder and file in the upgraded software (or version-up software), respectively, comparing the checksums of the software of the old version with the checksums of the upgraded software, identifying and extracting one of changed folder(s) and file(s), and generating a DB of information on the version history of the software including the version of the extracted folder or file, file properties, checksum, and version history.

Preferably, in the step for calculating the checksum, checksums of the folders, subfolders and files in the upgraded software are calculated, respectively, and in the step for extracting the changed folder(s) or file(s), the checksums of the folders, subfolders and files are sequentially compared to identify and extract the changed folder(s), subfolder(s) and file(s) in sequence.

Preferably, in the step for generating a DB, the information including the version history of the changed folder(s), subfolder(s) and file(s) that are extracted in the checksum comparison part, are classified in accordance with a version system of the software and are stored in the version managing DB.

### BRIEF DESCRIPTION OF THE DRAWINGS

The above aspects and features of the present invention will become more apparent by describing certain embodiments of the present invention with reference to the accompanying drawings, in which:

FIG. 1 illustrates a window showing folder and file structures of an existing software;

FIG. 2 is a block diagram of an auto version managing system for use in software according to an embodiment of the present invention;

FIG. 3 is a block diagram illustrating the structure of a version managing DB that is constructed by the auto version managing system of FIG. 2 according to an embodiment of the present invention;

FIG. 4 illustrates a window showing the properties of a software folder;

FIG. 5 illustrates a window showing the properties of a software file; and

FIG. 6 is a flow chart describing an auto version managing method embodied by the auto version managing system according to an embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will be described herein with reference to the accompanying drawings.

In the present invention, it can be assumed that software can contain all kinds of programs that can be loaded on a computer, such as an O/S, application program, device driver, and so on. The O/S program includes CP/M and MS-DOS, and Windows, which are developed as PC operation systems, UNIX systems which are developed for use with super-mini computers and work stations, and recently developed VMS or OS/2. Application programs include word processors such as MS Word and Word Perfect, Excel for use in accounting calculations for example, Photoshop for creating pictures, Notepad for writing an HTML document or looking at available HTML source code, and Internet Explorer or Navigator web browsers. Device drivers are software programs for interfacing devices with computers. Examples of device drivers are printer drivers, soundcard drivers, graphic card drivers, monitor drivers, CD-ROM drivers, and USB drivers. Device drivers are preferably installed when devices are connected to a computer. In recent years, drivers for a compatible device may be provided directly by the operating system.

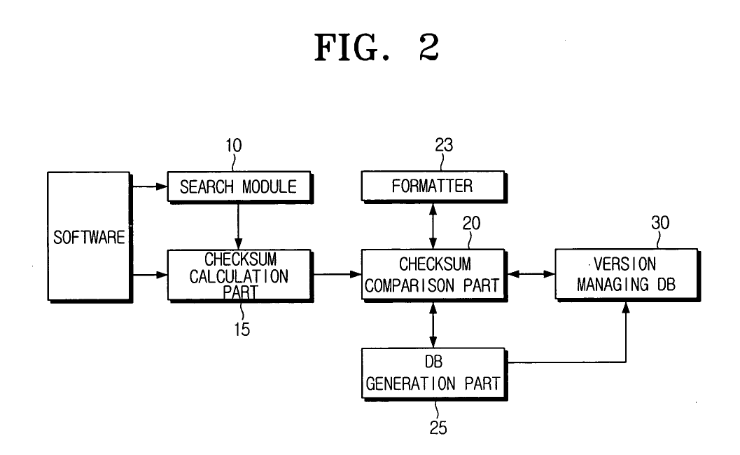

FIG. 2 is a schematic block diagram of an auto version managing system for use in building a version history of software. The auto version managing system according to an embodiment of the present invention includes a search module 10, a version managing DB 30, a checksum calculation part 15, a checksum comparison part 20, a DB generation part 25, and a formatter 23.

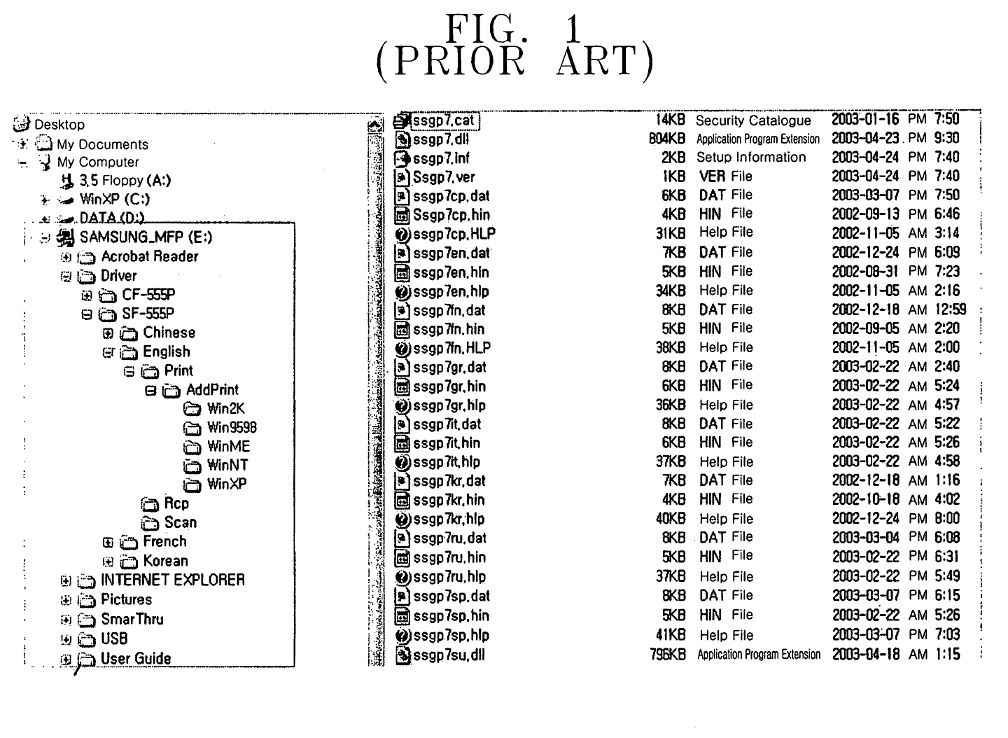

When an upgraded software (or version-up software) is provided by means of a CD, diskette, or network, the search module 10 reads the input upgraded software to determine the folder and file structure in the software, and indexes the files and folders. That is, the search module 10 indexes the directory of folders, multi-level subfolders, and files in the upgraded software according to hierarchical order, subject, programmer, date, and type of file as shown in FIG. 1. This indexing facilitates the comparison of the checksum of folders, subfolders, and files performed by the checksum comparison part 20, which is described in greater detail below. Thus, the checksum comparison part 20 can more accurately and conveniently extract objects to be compared in the upgraded software and the software of the old version, respectively.

The checksum calculation part 15 counts the bit numbers of the folders, subfolders, and files of the software, and calculates the checksums of the folders, subfolders, and files, respectively. Checksums are useful for determining that a digital file has been received accurately, or has not been changed. Normally, the checksum is used for a receiver to check whether the data of a file has been accurately received and thus, is transmitted together with a packet via a data transmission part (not shown). In a receiving computer, the checksum included in the transmitted packet is compared with a newly calculated checksum in the receiving computer. If the two checksums are the same, the receiver determines that the data has been accurately received. A checksum value calculated by the checksum calculation part 15 is used to identify and extract changed folders or files between the upgraded or version-up software and the software of the old version. That is, the checksum calculation part 15 calculates the checksums of folders, subfolders, and files in the upgraded software, respectively.

The checksum comparison part 20 compares the checksums of the folders, subfolders, and files in the software of the old version stored in the version managing DB 30, with the checksums of the folders, subfolders, and files in the upgraded software, respectively, to identify and then extract changed folders, subfolders, and files. Comparison of the checksums of the upgraded software and the software of the old version is conducted in the sequential order of first folders, then subfolders, and then files. That is, the checksum comparison part 20 first compares the checksum of the top-level folder in the software of the old version with the checksum of the top-level folder in the upgraded software. At this point, the top-level folder can be one or more folders, depending on the configuration or size of the software system. If the checksum comparison part 20 discovers a top-level folder with different checksums in the compared software, it determines that the corresponding folder in the upgraded software has been changed or modified.

Therefore, when a changed folder is discovered in the upgraded software, the checksum comparison part 20 fetches the checksum for the subfolder(s) under the changed folder of the upgraded version and the software of the old version, respectively. As shown in FIG. 1, there could be multi-level subfolders in a single software. Therefore, the checksum comparison part 20 sequentially compares checksums of subfolders in the upgraded software and the software of the old version. For example, the checksum comparison part 20 compares the checksum of each subfolder in the first level of the upgraded software and the software of the old version, respectively (such as CF-555P and SF-555P in FIG. 1). If the checksums of the SF-555P folders in the upgraded software and the software of the old version are different from each other, the checksum comparison part 20 selects the SF-555P folder. Next, the checksum comparison part 20 fetches the checksums of the subfolders of the SF-555P folder, that is, the Chinese folder, English folder, French folder, and Korean folder. By repeatedly performing this checksum comparison procedure on subfolders under the changed folder, the checksum comparison part 20 eventually identifies and extracts at least one changed file.

Accordingly, the checksum comparison part 20 compares the checksums of the upgraded software and the software of the old version step-by-step according to the hierarchy of folders, subfolders and files. At this point, the checksum comparison part 20 does not compare lower-level folders, subfolders and files having the same checksum. That is, after comparing folders, subfolders, and files in the upgraded software and the software of the old version, the checksum comparison part 20 selects only subfolder(s) of changed folder(s), and files of the changed subfolder(s) as objects of the checksum comparison procedure. Unlike the prior art methods where the binary file of every file was compared, in exemplary embodiments of the present invention the number of objects which are subject to the checksum comparison is significantly reduced. For example, if the checksum of a top-level folder in both the old and new software versions is the same, further version checking of all subfolders and files within the top-level folder can be avoided.

The version managing DB 30 stores earlier software release versions, such as 1.0, and software of each version that has been developed for improvement of performance or debugging. Also, the version managing DB 30 stores the history of each version.

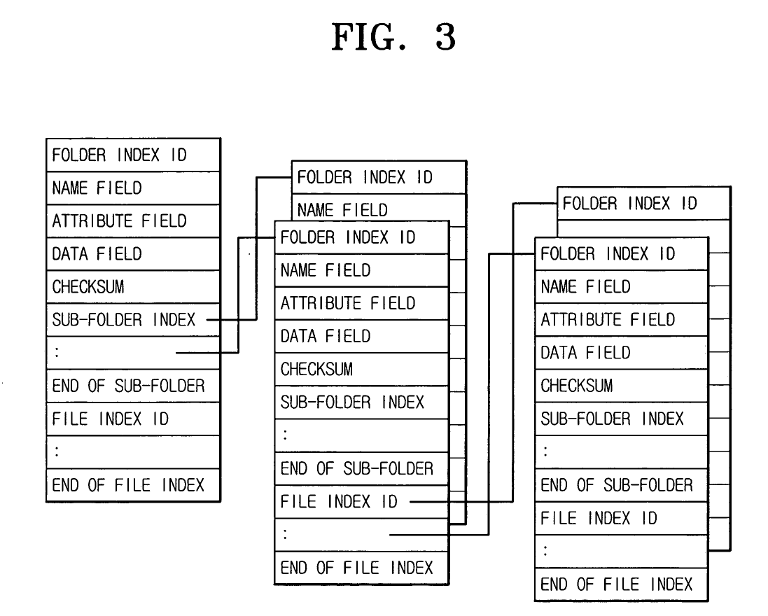

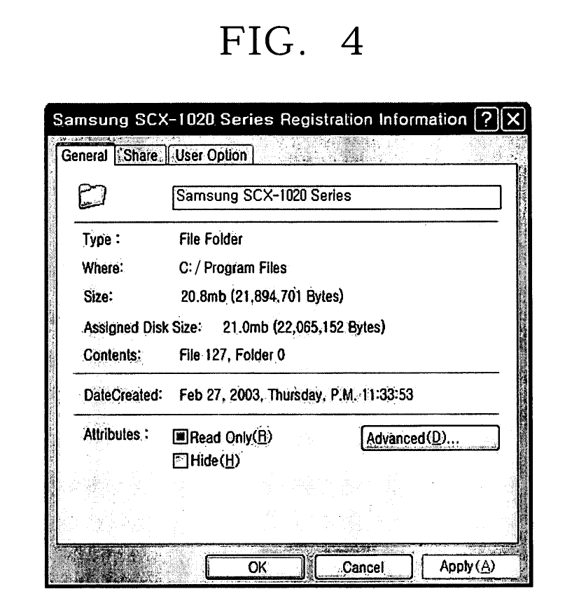

As shown in FIG. 3, the version managing DB 30 sets folders, subfolders, and files of each version of software into a record. Each field in the record formed by the folder(s) and subfolder(s) includes a folder index ID, folder name, folder properties, record date, checksum, and subfolder index connected to a corresponding folder. As illustrated in FIG. 4, the folder properties include folder type, location of folder, folder size, folder contents indicating the number of subfolders and files under the subject folder, create date, and attribute information about the folder indicating for example, whether the folder is read only or hidden.

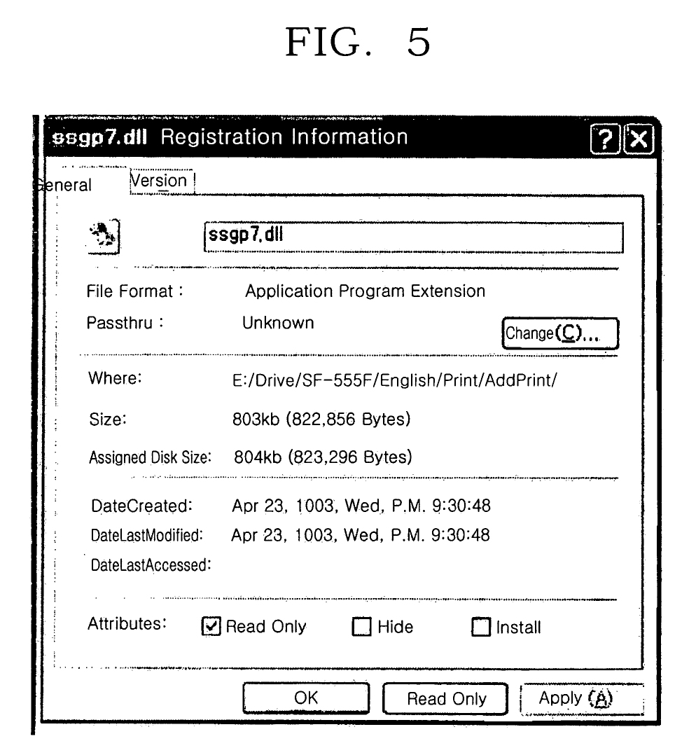

In each field of the file record, the lowest-level layer includes file index ID, file name, file properties, record date, file type, checksum, version information structure, and linked upper-level folder ID. As illustrated in FIG. 5, the file properties include file format based on file extension, such as *.exe, *com, *.dll, *.dat, *.bmp, and *inf, passthru for driving file, file size, assigned file size, create date, last modified date, last accessed date, and information about the file indicating whether the file is read only or hidden. The version information structure forming the record of the file further indicates the version of the file that can be executed on the window and other information. In an embodiment of the present invention, the version information structure can also be used as a reference for distinguishing whether the version naming scheme has not been observed, whether the version has not been changed, or whether file modification has been done unexpectedly. The version information structure is especially beneficial for the comparison of version information, checksum, time, and properties stored in the version managing DB 30.

As described above, the version managing DB 30 also stores the history of the version of software, specifically, information about changed folders, subfolders, and files that are extracted by the comparison of the upgraded software with the software of the old version. More specifically, the version managing DB 30 stores information about the changed folders, subfolders and files from the upgraded software that are identified and extracted by the checksum comparison part 20, wherein the information about the changed folders, subfolders and files includes properties, checksums, sizes, programmers, attributes, and formats in the upgraded software. Also, if it is determined that the software has been upgraded for debugging, the version managing DB 30 can further store information indicating which bug was generated in which folder or file, and how the debugging was done. This kind of information can be input personally by the programmer.

The DB generation part 25 determines the sequence of storage of the information about changed folders, subfolders and files extracted by the checksum comparison part 20 on the basis of the software version naming scheme. In general, a version number of software according to the version naming scheme includes two parts, that is, the primary version number in front of the decimal point, and the secondary version number after the decimal point. If functions and contents of the software have changed a great deal, the primary number of the version is changed, such as 2.0 to 3.0. If the change is minor, such as those involving debugging or troubleshooting only, the secondary number of the version is changed, such as 1.1 to 1.2. Accordingly, the DB generation part 25 sequences the versions of the software in numerical order, putting the smallest version number first, and stores information about changed folders, subfolders and files in each upgraded version as long as there are changes in the folders, subfolders and files after being compared with those in the old version of each. The DB generation part 25 then checks the version information structure. If it is determined that the version naming scheme has not been observed, that the version has not been changed, or that a file modification has been done unexpectedly, the DB generation part 25 provides the information to the formatter 23 to display an error message to the user through an output device such as monitor or printer.

The formatter 23 can be a module that displays the comparison results of the checksum comparison part 20 on the monitor, or prints the comparison results through a printer at the request of the DB generation part 25 for example. The formatter 23 formats the comparison results provided by the checksum comparison part 20 in the form of a change report, and outputs the report to the monitor or the printer. The change report includes information about the changed folders, subfolders and files based on the comparison of the upgraded software with the software of the old version.

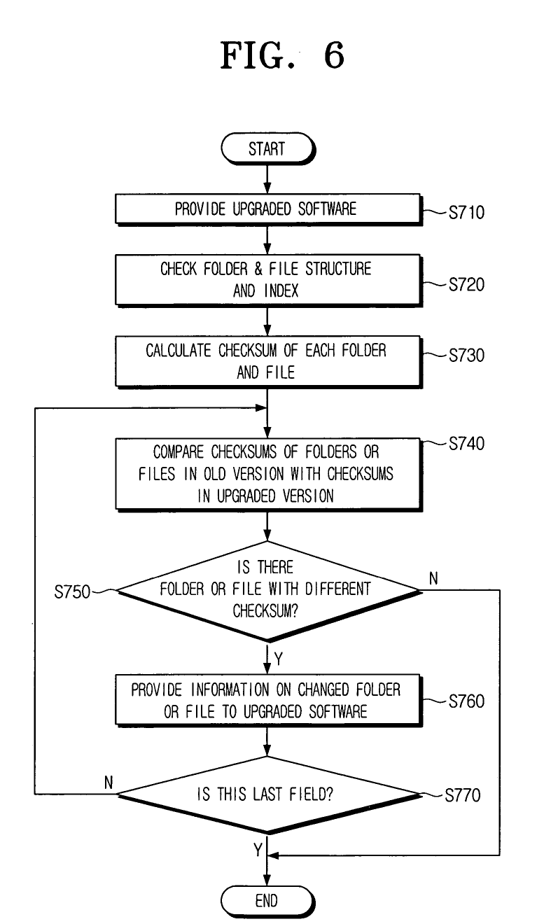

With reference to FIG. 6, a method will be described in greater detail for automatically generating version history information of software, which is embodied in the above-described auto version managing system according to an embodiment of the present invention.

When an upgraded software (or version-up software) is provided to the auto version managing system by means of a CD, diskette, or network at step (S710), the search module 10 reads the upgraded software to determine the folder and file structure in the software, and indexes the files and folders therein at step (S720). When the folders and file structures are indexed in sequence, the checksum calculation part 15 calculates the checksums for the indexed folders, subfolders and files of the software, respectively, and provides the checksum calculations to the checksum comparison part 20 at step (S730).

The checksum comparison part 20 fetches the information on the checksums of each folder, subfolder, and file in the software of the old version from the version managing DB 30, and receives the checksum calculations of each folder, subfolder, and file in the upgraded software from the checksum calculation part 15. The checksum comparison part 20 then compares the checksums of the top-level folders in the software of the old version with the checksums of the top-level folders in the upgraded software at step (S740). If a top-level folder exists having a different checksum at step (S750), the checksum comparison part 20 extracts the top-level folder with a different checksum from the upgraded software, and provides information about the extracted top-level folder to the DB generation part 25 at step (S760). If there are remaining fields such as subfolders under the extracted folder at step (S770), the method returns to step (S740).

After extracting the top-level folder having a different checksum, the checksum comparison part 20 then compares the checksums of the subfolders under the extracted top-level folder in the upgraded software and the software of the old version, respectively, at step (S740). As a result of the comparison, if there is a subfolder (or subfolders) having a different checksum from that of the old software at step (S750), the checksum comparison part 20 transfers information on the corresponding subfolder(s) to the DB generation part 25 at step (S760).

The checksum comparison part 20 further determines whether the checksums of the subfolders or files under the subfolder in question are different from those in the software of the old version at step (S740). If it is determined that there exists in the upgraded software subfolders or files having different checksums from those in the software of the old version at step (S750), the checksum comparison part 20 again extracts information on the corresponding subfolders or files, and provides the information to the DB generation part 25 at step (S760). The checksum comparison part 20 then determines whether a field that is used for the checksum comparison is the last field or file at step (S770), and if so, it ends the checksum comparison process.

While sequentially comparing the top-level folders down to the lowest-level files in the upgraded software with the software of the old version, the checksum comparison part 20 generates information indicating which folder(s) or subfolder(s) were subject to the checksum comparison, and whether checksum(s) of the folder(s) or subfolder(s) being compared were different from those in the software of the old version. In effect, this information is used in a next step for selecting subfolder(s) or file(s) for the checksum comparison. The information, if necessary, can be stored in the version managing DB 30.

Therefore, the checksum comparison part 20 sequentially compares the checksums of the top-level folders down to the lowest-level files only where required to do so. That is, the checksum comparison part 20 compares only the checksums of folders or low-level layers of the subfolder having a different checksum from the old version. In this manner, every file in the software is not subject to the checksum comparison, but only parts of folders, subfolders, and files with possibility of being upgraded are subject to the checksum comparison.

The extracted information about the changed folder(s), subfolder(s), and file(s) is transferred in real time mode to the DB generation part 25. The DB generation part 25 stores the information about the folder(s), subfolder(s), and file(s) which are upgraded or changed in the version managing DB 30 according to the version system of a corresponding software, and ultimately the version history of the software is generated.

As described above, the auto version managing system for use in software reads the folder and file structures in the upgraded software, indexes the folders and files, and calculates the checksum of each folder, subfolder, and file where required. The system then compares the checksums of the folders, subfolders, and files in the upgraded software with the checksums of folders, subfolders, and files in the software of the old version in order to select changed folder(s), subfolder(s), and file(s). Folder(s), subfolder(s), and file(s) having different checksums from those in the software of the old version are regarded as modified or changed. Information about the changed folder(s), subfolder(s), and file(s) can then be stored in the version managing DB 30 according to the version system, and in this manner, the history of the software version is generated.

The auto version managing system for use in software, therefore, can be advantageously used for more conveniently and quickly checking the changed folder(s), subfolder(s), and file(s) in the upgraded software, and for automatically creating a database of the version history of the software. It also becomes possible to trace the history of the version in the database. Therefore, since the time, effort, and cost wasted in the traditional version managing systems such as manually performed comparisons or the use of file comparison tools are saved, productivity can be increased. In addition, unlike the traditional version managing systems where mistakes can be easily made by programmers or others, fewer mistakes are made by the present invention system so it becomes possible to prevent deterioration in product quality.

The foregoing embodiments and advantages are merely exemplary and are not to be construed as limiting the present invention. The present teachings can be readily applied to other types of apparatuses. Also, the description of the embodiments of the present invention is intended to be illustrative, and not to limit the scope of the claims, and many alternatives, modifications, and variations will be apparent to those skilled in the art.

1. An auto version managing system for managing a version history of software, the system comprising:
a search module for searching at least one folder and file structure in the software, and for indexing the folder and file structure;
a version managing database (DB) for storing software version information including at least one of software version, file properties, checksum, and version history;
a checksum calculation part for calculating a checksum of at least one folder or at least one file;
a checksum comparison part for comparing checksums of an old software version that are stored in the version managing DB with checksums of an upgraded software to identify a changed folder or changed file, and for extracting at least one of the changed folder and changed file; and
a DB generation part for storing information in the version managing DB about the extracted folder or extracted file.

2. The system according to claim 1, wherein the software comprises at least one of an operating system, application program, and device driver.

3. The system according to claim 1, wherein the checksum calculation part is configured to calculate a checksum of at least one of a plurality of folders, subfolders and files in the upgraded software; and
wherein the checksum comparison part is further configured to sequentially compare the checksums of the folders, subfolders and files to identify a changed folder or file and extract at least one of the changed folders, subfolders and files.

4. The system according to claim 1, wherein the DB generation part is configured to classify the information comprising a version history of the changed folders, subfolders and files that are extracted in accordance with a version system of the software, and store the information in the version managing DB.

5. An auto version managing method for the management of a version history of an upgraded software, the method comprising the steps of:
searching at least one folder and file structure in the software, and indexing the folder and file structure;
calculating a checksum of at least one folder or at least one file in the upgraded software;
comparing checksums of an old software version with checksums of the upgraded software to identify a changed folder or file, and extracting one of the changed folders or files; and
generating a database (DB) of information on the version history of the software.

6. The method according to claim 5, wherein the DB of information on version history comprises at least one of a version of the extracted folder, version of the extracted file, file properties, checksum, and version history.

7. The method according to claim 5, wherein the step for calculating a checksum further comprises the step of:
calculating checksums of at least one of a plurality of folders, subfolders and files in the upgraded software

8. The method according to claim 7, wherein the step for extracting the changed folders or files further comprises the step of:
sequentially comparing the checksums of the folders, subfolders and files to extract at least one of the changed folders, subfolders and files.

9. The method according to claim 7, wherein the step for generating a DB further comprises the step of:
classifying the information comprising a version history of the changed folders, subfolders and files that are extracted in accordance with a version system of the software.

10. The method according to claim 9, wherein the step for generating a DB further comprises the step of storing the information in the version managing DB.
